(19) United States
(12) Patent Application Publication
(10) Pub. No.: US 2012/0270065 A1
(43) Pub. Date: Oct. 25, 2012

(54) MULTI-LAYERED STRUCTURE AND MANUFACTURING METHOD THEREOF

(76) Inventors: Takamasa Maekawa, Ibaraki (JP); Toshiya Kurihara, Ibaraki (JP); Takashi Kosho, Ibaraki (JP)

(21) Appl. No.: 13/386,984

(22) PCT Filed: May 12, 2011
(86) PCT No.: PCT/JP2011/060971

§ 371 Date: Jan. 25, 2012

(30) Foreign Application Priority Data
Aug. 31, 2010 (JP) 2010-194547

(51) Int. Cl. B32B 15/04; B05D 1/36

(52) U.S. Cl. 428/641; 428/642; 428/457; 428/334; 427/404

(57) ABSTRACT

The present invention provides a multi-layered structure, where contamination of impurities into indium target is excellently prevented, and manufacturing method thereof. The multi-layered structure comprises:
a backing plate,
an impurity diffusion prevention layer, comprising thin film consisting of one or more metals selected from Fe, W, Ta, Te, Nb, Mo, S and Si, formed on the backing plate, and
an indium target, formed on the impurity diffusion prevention layer.

### TECHNICAL FIELD OF THE INVENTION

The present invention relates to a multi-layered structure and manufacturing method thereof. In particular, the present invention relates to a multi-layered structure, comprising backing plate and indium target, and manufacturing method thereof.

### BACKGROUND OF THE INVENTION

Indium is used as a sputtering target for forming photoabsorption layer of Cu—In—Ga—Se system (CIGS system) thin-film solar cell.

Traditionally, as disclosed in Patent document 1, an indium target is formed by attaching indium alloy and the like, on a backing plate, and then pouring indium into a mold and casting them.

(Patent documents 1) Japanese Examined Patent Publication No. 63-44820

### SUMMARY OF THE INVENTION

Patent document 1 describes diffusion of impurities in backing plate, into indium, can be prevented by forming nickel thin film of several μm in thickness, on the backing plate. However, in its working examples, concentration of the impurities in the indium target is not measured. Further, according to conducting the working examples disclosed in Patent document 1 by inventors of the present invention, it has turned out that copper, which is a constituent element of the backing plate, is contained 15 ppm in the indium target, through the nickel thin film. Beside, when alloy, consisting of indium and impurity element such as tin, is used as bonding material, recovering and recycling the indium target, after using it in sputtering, require great care in removing impurity elements except indium and control of the concentration. Therefore, it causes problems with regard to manufacturing efficiency and manufacturing cost.

The present invention aims to provide a multi-layered structure, where contamination of impurities into indium target is excellently prevented, and manufacturing method thereof.

The inventors have diligently studied to cope with the requirements, and eventually have found out, by forming impurity diffusion prevention layer, comprising thin film consisting of specific metals, between a backing plate and indium target, multi-layered structure, where contamination of impurities into indium target is excellently prevented, can be produced, and thereby great care of removing impurities and controlling concentration can be unrequisite and their costs can be reduced, when recycling indium target.

The present invention, produced on the basis of the above findings, in one aspect, is a multi-layered structure comprising:
a backing plate,
an impurity diffusion prevention layer, comprising thin film consisting of one or more metals selected from Fe, W, Ta, Te, Nb, Mo, S and Si, formed on the backing plate, and
an indium target, formed on the impurity diffusion prevention layer.

The present invention is, in one embodiment, the multi-layered structure, wherein the impurity diffusion prevention layer is made of the thin film consisting of Fe.

The present invention is, in another embodiment, the multi-layered structure, wherein the thin film consisting of Fe is formed by non-electrolytic plating.

The present invention is, in yet another embodiment, the multi-layered structure, wherein the impurity diffusion prevention layer is 5 μm to 100 μm in thickness.

The present invention is, in yet another embodiment, the multi-layered structure, wherein concentration of copper is 5 ppm or less and concentration of iron is 8 ppm or less, in the indium target.

The present invention, in another aspect, is a manufacturing method of a multi-layered structure comprising:
a process for preparing a backing plate,
a process for forming an impurity diffusion prevention layer, comprising thin film consisting of one or more metals selected from Fe, W, Ta, Te, Nb, Mo, S and Si, on the backing plate, and
a process for forming an indium target by melting and casting raw indium on the backing plate.

The present invention is, in one embodiment, the manufacturing method of a multi-layered structure wherein the impurity diffusion prevention layer is made of the thin film consisting of Fe.

The present invention is, in another embodiment, the manufacturing method of a multi-layered structure wherein the thin film consisting of Fe is formed by non-electrolytic plating.

### ADVANTAGEOUS EFFECT OF THE INVENTION

The present invention can provide a multi-layered structure, where contamination of impurities into indium target is excellently prevented, and manufacturing method thereof.

### DESCRIPTION OF THE PREFERRED EMBODIMENTS

A multi-layered structure of the present invention comprises a backing plate, an impurity diffusion prevention layer, formed on the backing plate, and an indium target, formed on the impurity diffusion prevention layer. A shape of the backing plate is not limited in particular, but the backing plate can be formed in the shape of disk having predetermined thickness and diameter. Constituent material of the backing plate is not limited in particular, but the backing plate can be made of, for example, metal materials such as copper. As described above, the impurity diffusion prevention layer is formed between the backing plate and the indium target, and it has a function of preventing diffusion of impurities, from the backing plate into the indium target. Constituent material of the impurity diffusion prevention layer is preferably selected from materials where the constituent material of the backing plate is difficult to diffuse. As such constituent materials of the impurity diffusion prevention layer, for example, Fe, W, Ta, Te, Nb, Mo, S, Si and the like can be used. For example, when the main constituent material of the backing plate is copper, the impurity diffusion prevention layer is preferably made of iron that prevents diffusion of copper excellently. Iron hardly mixes in the indium by dissolving because solid solubility limit of iron in the indium is very low. Therefore, when the impurity diffusion prevention layer is thin film made of iron, diffusion of the constituent material of the impurity diffusion prevention layer itself, into the indium target, can also be prevented excellently. The thickness of the impurity diffusion prevention layer is preferably 5 μm to 100 μm. If the thickness of the impurity diffusion prevention layer is less than 5 μm, sufficient impurities diffusion prevention effect cannot be provided. Even if the thickness of the impurity diffusion prevention layer is more than 100 μm, the impurities diffusion prevention effect is saturated. Therefore, there is little need to increase the thickness any more. Contamination of impurities into the target is excellently prevented because the indium target is formed on the impurity diffusion prevention layer. In particular, when copper and iron could be contained in the indium target as impurities, the concentration of copper is preferably 5 ppm or less, the concentration of iron is preferably 8 ppm or less, the concentration of copper is more preferably 3 ppm or less, and the concentration of iron is more preferably 4 ppm or less. Further, if necessary, in addition to the impurity diffusion prevention layer, a thin film may be formed between the backing plate and the indium target, in order to bond them excellently.

Next, an appropriate example of a manufacturing method, of the multi-layered structure of the present invention, will be explained step by step. At first, the backing plate having predetermined thickness is prepared, and then the impurity diffusion prevention layer is formed on the backing plate. A manufacturing method of the impurity diffusion prevention layer is not limited in particular, and the layer can be formed by non-electrolytic plating, sputtering, coating and drying of materials, and the like, depending on its constituent material. When the impurity diffusion prevention layer is thin film made of iron, the thin film made of iron is preferably formed by the non-electrolytic plating that is a simple and low-cost forming method of thin film.

Next, cylindrical mold is set on the backing plate where the impurity diffusion prevention layer is formed. Next, melted raw indium is poured into the mold. The raw indium to be used, preferably is high purity, because conversion efficiency of solar cell, formed with the raw material, deteriorates when impurities are contained in the raw indium. For example, raw indium of 99.99 mass % or more in purity can be used for the raw material. Thereafter, the indium target is formed by cooled to room temperature. A rate of the cooling may be provided by natural cooling by air. If necessary, surface treatment such as surface polishing may be conducted on the indium target.

The multi-layered structure produced thereby can be suitably used as a sputtering target for forming photoabsorption layer of CIGS system thin-film solar cell.

### EXAMPLES

Examples of the present invention, with comparative examples, will be described as follows, but the following examples are provided for better understanding of the present invention and its advantages, and intended to be non-limiting.

### Inventive Example 1

A backing plate made of copper, of 250 mm in diameter and 5 mm in thickness, was prepared. Next, plating solution was prepared by mixing ferric chloride solution where concentration of iron is 2 mol/L, octyl sodium sulfate (0.5×10⁻³ mol/L) as surface acting agent, and calcium chloride (1.5 mol/L). Then, with the plating solution, thin film, made of iron, of 20 μm in thickness, was formed on the backing plate by non-electrolytic plating. Next, a cylindrical mold of 205 mm in diameter and 7 mm in height, was placed to surround the thin film made of iron formed on the backing plate. Next, raw indium (purity: 5N), which was melted in 160° C., was poured into the inside of the mold and then cooled to room temperature. Then disk-shaped indium target (diameter: 204 mm×thickness: 6 mm) was produced, and thereby a multi-layered structure was produced.

### Inventive Example 2

A multi-layered structure was produced in a manner similar to the inventive example 1, except that a thin film made of iron was 100 μm in thickness.

### Inventive Example 3

A multi-layered structure was produced in a manner similar to the inventive example 1, except that a thin film made of iron was 5 μm in thickness.

### Inventive Example 4

A multi-layered structure was produced in a manner similar to the inventive example 1, except that a thin film made of iron was 4 μm in thickness.

### Inventive Example 5

A multi-layered structure was produced in a manner similar to the inventive example 1, except that a thin film made of iron was 120 μm in thickness.

### Comparative Example 1

A multi-layered structure was produced in a manner similar to the inventive example 1, except that a thin film made of iron was not formed.

### Evaluation

Concentrations of impurities in the targets of the produced multi-layered structure, produced in the inventive examples and the comparative example, were measured by ICP analysis method. The results of the measurements are shown in Table 1.

TABLE 1

| | Thickness of | | |
|---|---|---|---|
| | impurity | | |
| | diffusion | concentration | concentration |
| | prevention | of copper | of iron |
| | layer(μm) | (ppm) | (ppm) |
| inventive example 1 | 20 | 2 | 2 |
| inventive example 2 | 100 | <1 | 4 |
| inventive example 3 | 5 | 4 | <1 |
| inventive example 4 | 4 | 7 | <1 |
| inventive example 5 | 120 | <1 | 5 |
| comparative example 1 | — | 3000 | — |

The results of inventive examples 1 to 3 show that diffusions of copper and iron into indium were excellently prevented because the thickness of the thin films made of iron (impurity diffusion prevention layer) was 5 μm to 100 μm.

The result of inventive example 4 shows that concentration of copper in the indium was slightly higher than that of the inventive example 3 because the thickness of the thin film made of iron (impurity diffusion prevention layer) was 4 μm, which was slightly thinner. However, it might be said that diffusion of copper was excellently prevented because concentration of copper in the indium was 7 ppm.

The result of inventive example 5 shows that concentration of iron in the indium was higher than that of the inventive example 2 because the thickness of the thin film made of iron (impurity diffusion prevention layer) was 120 μm, which was slightly thicker. However, it might be said that diffusion of copper was excellently prevented because concentration of copper in the indium was less than 1 ppm.

The result of comparative example 1 shows that concentration of copper in the indium was 3000 ppm, which was very high, because the thin film made of iron (impurity diffusion prevention layer) was not formed, and as the result, an amount of the diffusion into the indium target was large.

1. A multi-layered structure comprising:
a backing plate,
an impurity diffusion prevention layer, comprising a thin film consisting of one or more metals selected from Fe, W, Ta, Te, Nb, Mo, S and Si, formed on the backing plate, and
an indium target, formed on the impurity diffusion prevention layer.

2. The multi-layered structure of claim 1, wherein the impurity diffusion prevention layer is made of a thin film consisting of Fe.

3. The multi-layered structure of claim 2, wherein a thin film consisting of Fe is formed by non-electrolytic plating.

4. The multi-layered structure of claim 1, wherein the impurity diffusion prevention layer is 5 μm to 100 μm in thickness.

5. The multi-layered structure of claim 1, wherein the concentration of copper is 5 ppm or less and concentration of iron is 8 ppm or less, in the indium target.

6. A manufacturing method of a multi-layered structure comprising:
a process for preparing a backing plate,
a process for forming an impurity diffusion prevention layer, comprising a thin film consisting of one or more metals selected from Fe, W, Ta, Te, Nb, Mo, S and Si, on the backing plate, and
a process for forming an indium target by melting and casting raw indium on the backing plate.

7. The manufacturing method of a multi-layered structure of claim 6, wherein the impurity diffusion prevention layer is made of the a thin film consisting of Fe.

8. The manufacturing method of a multi-layered structure of claim 7, wherein a thin film consisting of Fe is formed by non-electrolytic plating.
